(19) United States
(12) Patent Application Publication
(10) Pub. No.: US 2007/0150658 A1
(43) Pub. Date: Jun. 28, 2007

(54) Pinning locks in shared cache

(76) Inventors: Jaideep Moses, Portland, OR (US); Ravishankar Iyer, Portland, OR (US); Ramesh G. Illikkal, Portland, OR (US); Srihari Makineni, Portland, OR (US); Donald Newell, Portland, OR (US)

Correspondence Address: CAVEN & AGHEVLI;c/o INTELLEVATE, P.O. BOX 52050, MINNEAPOLIS, MN, 55402, US

(21) Appl. No.: 11/319,897

(22) Filed: Dec. 28, 2005

(51) Int. Cl. G06F 12/00

(52) U.S. Cl. 711/130

(57) ABSTRACT

Methods and apparatus to pin a lock in a shared cache are described. In one embodiment, a memory access request is used to pin a lock of one or more cache lines in a shared cache that correspond to the memory access request.

### BACKGROUND

The present disclosure generally relates to the field of electronics. More particularly, an embodiment of the invention relates to pinning locks in a shared cache.

To improve performance, some processors utilize multiple cores to execute different threads. These processors may also include a cache that is shared between the cores. As multiple threads attempt to access a locked line in a shared cache, a significant amount of snoop traffic may be generated. Additional snoop traffic may also be generated because the same line may be cached in other caches, e.g., lower level caches that are closer to the cores. Furthermore, each thread may attempt to test the lock and acquire it if it is available. The snoop traffic may result in memory access latency. The snoop traffic may also reduce the bandwidth available on an interconnection that allows the cores and the shared cache to communicate. As the number of cores grows, additional snoop traffic may be generated. This additional snoop traffic may increase memory access latency further and limit the number of cores that can be efficiently incorporated in the same processor.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 5, and 6 illustrate block diagrams of embodiments of computing systems, which may be utilized to implement various embodiments discussed herein.

FIG. 2 illustrates a block diagram of portions of a shared cache and other components of a processor core, according to an embodiment of the invention.

FIG. 3 illustrates a block diagram of an embodiment of a method to lock one or more lines of a shared cache.

FIG. 4 illustrates a block diagram of an embodiment of a method to update a lock in a shared cache.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

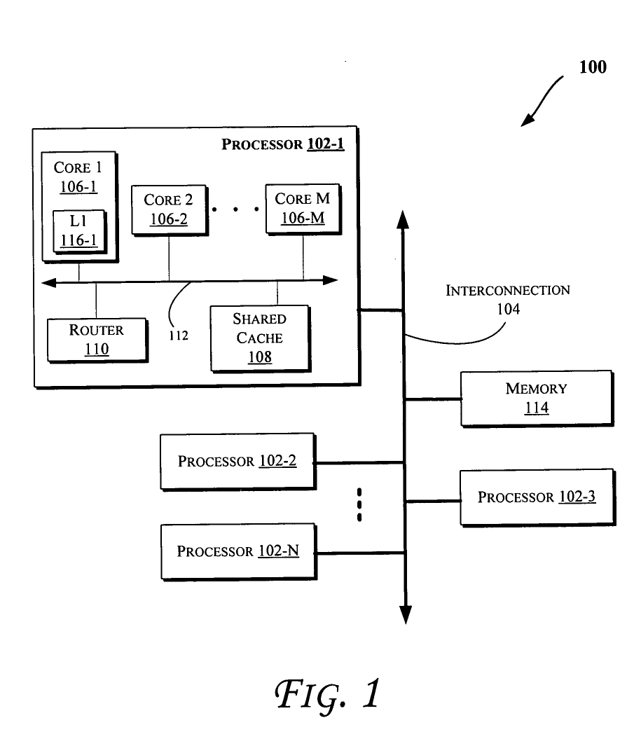

Some of the embodiments discussed herein may provide efficient mechanisms for pinning locks in a shared cache. In an embodiment, pinning locks in a shared cache may reduce the amount of snoop traffic generated in computing systems that include multiple processor cores, such as those discussed with reference to FIGS. 1, 5, and 6. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

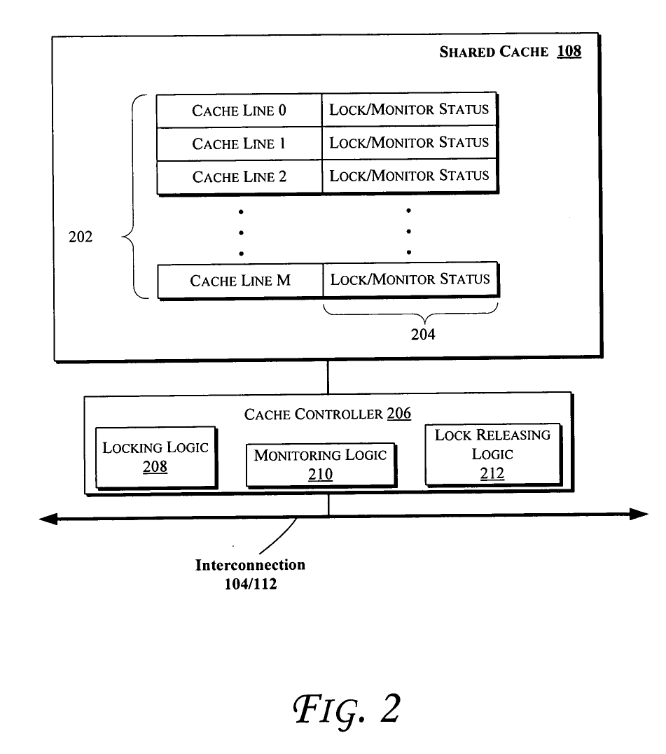

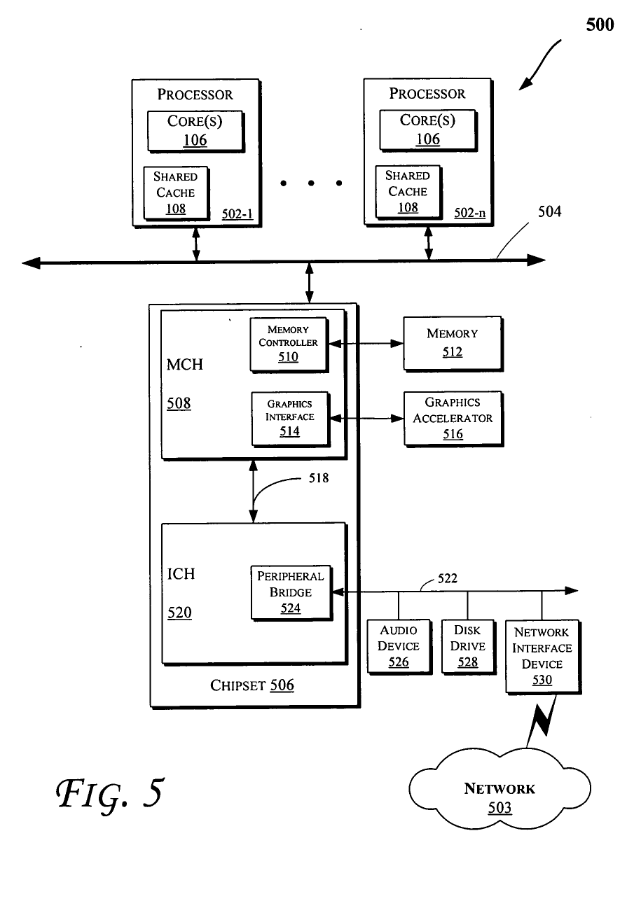

In an embodiment, the processor 102-1 may include one or more processor cores 106-1 through 106-M (referred to herein as “cores 106,” or more generally as “core 106”), a shared cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), memory controllers (such as those discussed with reference to FIGS. 2 and 5), or other components.

In one embodiment, the router 110 may be used to communicate between various components of the processor 102-1 and/or system 100. Moreover, the processor 102-1 may include more than one router 110. Furthermore, the multitude of routers (110) may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by the components of the processor 102. As shown in FIG. 1, the memory 114 may be in communication with the processors 102 via the interconnection 104. In an embodiment, the cache 108 (that may be shared) may be a last level cache (LLC). Also, each of the cores 106 may include a level 1 (L1) cache (116-1) (generally referred to herein as “L1 cache 116”). Furthermore, the processor 102-1 may also include a mid-level cache that is shared by several cores (106). Various components of the processor 102-1 may communicate with the shared cache 108 directly, through a bus (e.g., the bus 112), and/or a memory controller or hub. In an embodiment, the cores 106 may access the shared cache 108 with the same latency. For example, the shared cache 108 may be an equal distance (e.g., in terms of electrical signal propagation time) from each of the cores 106.

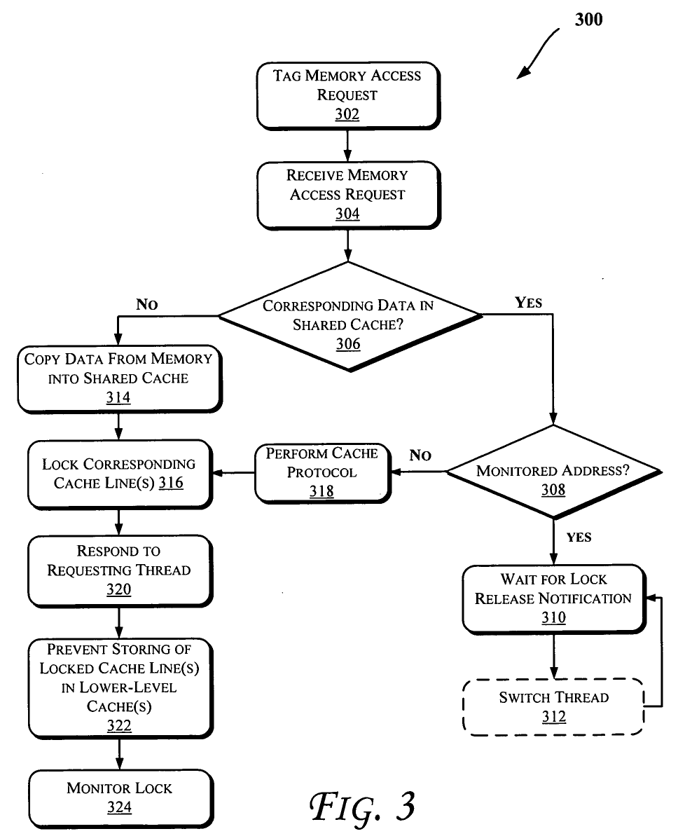

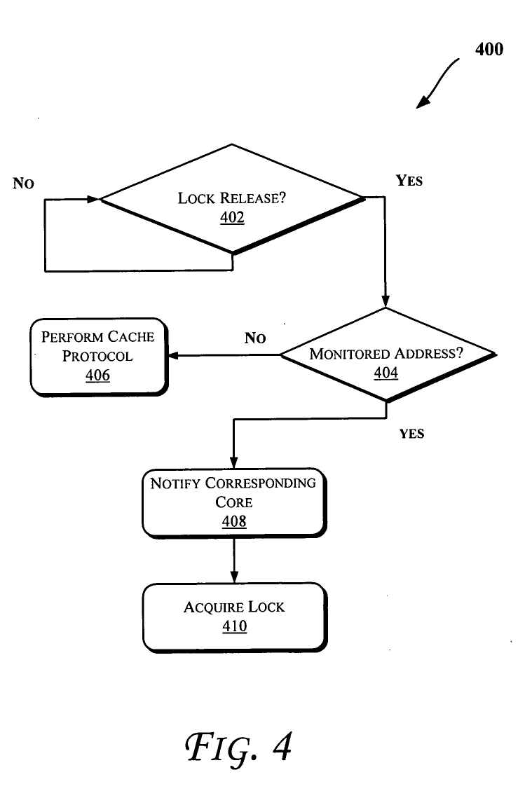

FIG. 2 illustrates a block diagram of portions of a shared cache 108 and other components of a processor core, according to an embodiment of the invention. As shown in FIG. 2, the shared cache 108 may include one or more cache lines (202). The shared cache 108 may also include one or more lock/monitor status bits (204) for each of the cache lines (202), as will be further discussed with reference to FIGS. 3 and 4. In one embodiment, one bit may be utilized to indicate whether the corresponding cache line is locked and another bit may be used to indicate whether the corresponding cache line is monitored (or pinned) in the shared cache 108. Alternatively, a single bit (204) may be utilized to indicate whether the corresponding cache line is locked (and optionally monitored) as will be further discussed with reference to FIGS. 3 and 4.

As illustrated in FIG. 2, the shared cache 108 may communicate via one or more of the interconnections 104 and/or 112 discussed with reference to FIG. 1 through a cache controller 206. The cache controller 206 may include logic for various operations performed on the shared cache. For example, the cache controller 206 may include a locking logic 208 (e.g., to lock one or more cache lines 202 in the shared cache 108), a monitoring logic 210 (e.g., to monitor one or more addresses in the shared cache 108 that correspond to one or more pinned and locked cache lines as will be further discussed with reference to FIGS. 3 and 4), and/or a lock forwarding logic 212 (e.g., to determine which one of a plurality of processor cores is notified when one or more locked cache lines of the shared cache 108 are unlocked or released, as will be further discussed with reference to FIG. 4). Alternatively, one or more of the logics 208, 210, and/or 212 may be provided within other components of the processors 102 of FIG. 1

FIG. 3 illustrates a block diagram of an embodiment of a method 300 to lock one or more lines of a shared cache. In an embodiment, various components discussed with reference to FIGS. 1-2, 5 and 6 may be utilized to perform one or more of the operations discussed with reference to FIG. 3. For example, the method 300 may be used to lock one or more cache lines 202 of FIG. 2.

Referring to FIGS. 1-3, at an operation 302, the core 106 may tag a memory access request, e.g., to request pinning a lock of addresses that correspond to the tag in the shared cache 108. In one embodiment, the core 106 may tag the memory access request in response to a request for locking one or more cache lines. In accordance with at least one instruction set architecture, a compare and exchange instruction may be used to request locking of one or more cache lines. Alternatively, an instruction with a “lock” prefix may be used. In an embodiment, the core 106 may tag the memory access request with a pin indicia that is detected by the locking logic 208 and/or cache controller 206, e.g., as will be further discussed herein with reference to operation 316. Hence, the pin indicia may correspond to one or more cache lines (202) whose locks are to be pinned in the shared cache 108.

At an operation 304, the shared cache 108 may receive the memory access request of the operation 302, for instance, via the interconnection 104 such as discussed with reference to FIGS. 1 and 2. At an operation 306, the cache controller 206 may determine whether data corresponding to the received memory access request are present in the shared cache 108 (e.g., in one or more of the cache lines 202). If the data is present in the shared cache 108, the monitoring logic 210 may determine whether one or more addresses corresponding to the received memory access request are being monitored (308), e.g., by referring to the value stored in the corresponding lock/monitor status bit(s) 204, such as discussed with reference to FIG. 2. If the addresses are being monitored (308), the monitoring logic 210 may send a response to the thread (and/or the processor core executing the thread) that requested the memory access (302) to wait for lock release notification (310). For example, one or more threads that are contending for the one or more locked cache lines may locally spin until the one or more locked cache lines are unlocked, as will be further discussed with reference to FIG. 4. At an operation 312, the core (106) executing the requesting thread may optionally be switched out of the corresponding core (106), e.g., to allow the processor core to execute another thread.

If the data corresponding to the received memory access request is absent from the shared cache 108 at operation 306, the cache controller 206 may copy the data into the shared cache 108 from a memory 114 (314). At an operation 316, the locking logic 208 may lock one or more cache lines (202) in the shared cache 108 that correspond to the received memory access request (304), e.g., by upda ting one or more bits in the corresponding lock/monitor status bits (204), as discussed with reference to FIG. 2. For example, one or more bits in the corresponding lock/monitor status bits (204) may be updated to indicate that the corresponding cache line is locked and/or monitored.

As shown in FIG. 3, if at operation 308 the monitoring logic 210 determines that the one or more addresses are not monitored, e.g., by referring to the value stored in the corresponding lock/monitor status bit(s) 204, one or more cache protocols may be performed (318). For example, the cache controller 206 may updated the shared cache 108 in accordance with cache coherence protocol(s) at the operation 318. After operation 318, the method 300 may continue with the operation 316. At an operation 320, the locking logic 208 may respond to the requesting threat (and/or the processor core executing the thread) with the requested data.

At an operation 322, the core (106) executing the requesting thread and/or the cache controller 206 pin the locked cache lines of the operation 316 by preventing one or more caches that have a lower level than the shared cache 108 (such as the L1 cache 116-1 or a mid-level cache) from storing the locked cache line(s). A lower level cache as discussed herein generally refers to a cache that is closer to a processor core (106). In an embodiment, the core (106) executing the requesting thread and/or the cache controller 206 may prevent lower level caches from storing the locked cache line(s), e.g., by observing the corresponding lock/monitor status bit(s) 204. At an operation 324, the monitoring logic 210 may monitor the locked cache lines of operation 316, e.g., to suspend one or more memory requests to these cache lines until the cache lines are unlocked or released.

FIG. 4 illustrates a block diagram of an embodiment of a method 400 to update a lock in a shared cache. In an embodiment, various components discussed with reference to FIGS. 1-2, 5 and 6 may be utilized to perform one or more of the operations discussed with reference to FIG. 4. For example, the method 400 may be used to release one or more locks in the shared cache 108 of FIGS. 1 and 2.

Referring to FIGS. 1-4, at an operation 402, the monitoring logic 210 may determine whether one or more locks present in the shared cache 108 have been released (or otherwise unlocked), e.g., by referring to the value stored in the corresponding lock/monitor status bit(s) 204. If not locks have been released, the method 400 continues performing the operation 402. Otherwise, at an operation 404, the monitoring logic 210 may determine whether one or more addresses corresponding to the released lock are monitored (such as discussed with reference to the operation 308), e.g., by referring to the value stored in the corresponding lock/monitor status bit(s) 204. If the one or more addresses are not being monitored, at an operation 406, one or more cache protocols may be performed (318). For example, the cache controller 206 may updated the shared cache 108 in accordance with cache coherence protocol(s) at operation 406.

At operation 408, the lock forwarding logic 212 may notify a processor core (e.g., one of the cores 106 that are contending for the locked cache lines) that the locked cache line(s) of the operation 316 are unlocked. As discussed with reference to FIG. 2, the lock forwarding logic 212 may determine which one of a plurality of processor cores 106 is notified (408) when one or more locked cache lines of the shared cache 108 are unlocked. The plurality of processor cores (106) may be cores that execute a plurality of threads that are contending for the one or more locked cache lines in the shared cache 108. For example, the lock forwarding logic 212 may maintain a buffer per pinned lock to keep track of the contending threads. When a lock is released (402), the lock forwarding logic 212 may determine which core (106) should be notified (408) to acquire the lock at an operation 410 (such as discussed with reference to operations 302 and 316, for example). In various embodiments, the lock forwarding logic 212 may choose a core for the operation 408 based on thread priority. In an embodiment, updates to the locks (e.g., release at operation 402 or acquire at operation 410) may be performed by using a write-through memory transaction or an atomic read, modify, and write memory transaction.

FIG. 5 illustrates a block diagram of a computing system 500 in accordance with an embodiment of the invention. The computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. In an embodiment, one or more of the processors 502 may be the same or similar to the processors 102 of FIG. 1. For example, one or more of the processors 502 may include one or more of the cores 106 and/or shared cache 108. Also, the operations discussed with reference to FIGS. 1-4 may be performed by one or more components of the system 500.

A chipset 506 may also communicate with the interconnection network 504. The chipset 506 may include a memory control hub (MCH) 508. The MCH 508 may include a memory controller 510 that communicates with a memory 512 (which may be the same or similar to the memory 114 of FIG. 1). The memory 512 may store data, including sequences of instructions that are executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The MCH 508 may also include a graphics interface 514 that communicates with a graphics accelerator 516. In one embodiment of the invention, the graphics interface 514 may communicate with the graphics accelerator 516 via an accelerated graphics port (AGP). In an embodiment of the invention, a display (such as a flat panel display) may communicate with the graphics interface 514 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 518 may allow the MCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530 (which is in communication with the computer network 503). Other devices may communicate via the bus 522. Also, various components (such as the network interface device 530) may communicate with the MCH 508 in some embodiments of the invention. In addition, the processor 502 and the MCH 508 may be combined to form a single chip. Furthermore, the graphics accelerator 516 may be included within the MCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

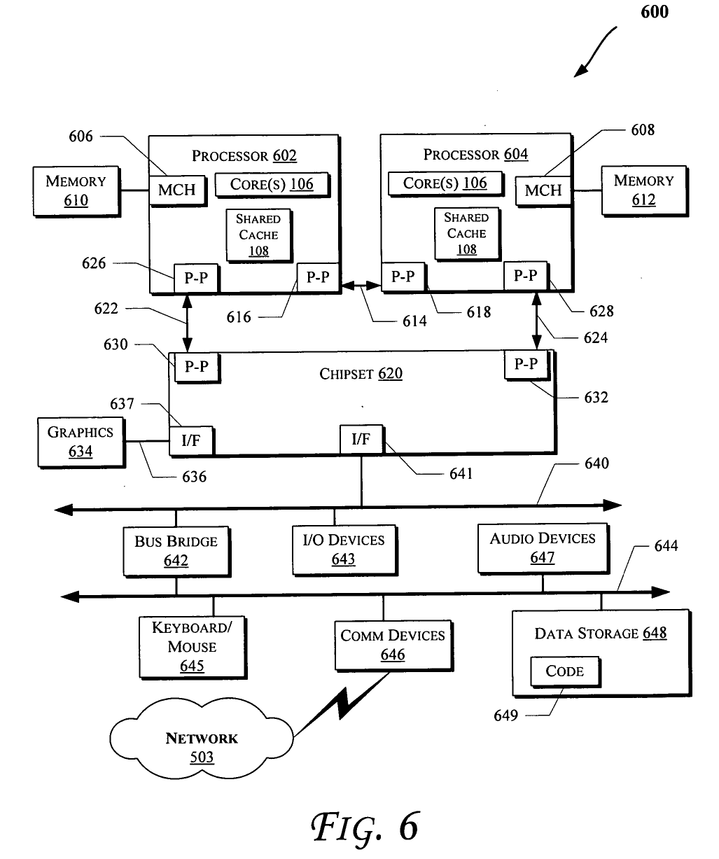

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 512 of FIG. 5.

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a high-performance graphics circuit 634 via a high-performance graphics interface 636, e.g., using a PtP interface circuit 637.

At least one embodiment of the invention may be provided within the processors 602 and 604. For example, one or more of the cores 106 and/or shared cache 108 of FIG. 1 may be located within the processors 602 and 604. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may communicate with a bus 640 using a PtP interface circuit 641. The bus 640 may have one or more devices that communicate with it, such as a bus bridge 642 and I/O devices 643. Via a bus 644, the bus bridge 643 may communicate with other devices such as a keyboard/mouse 645, communication devices 646 (such as modems, network interface devices, or other communication devices that may communicate with the computer network 503), audio I/O device, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-6.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a shared cache to receive a memory access request to pin a lock in the shared cache; and
logic to lock one or more cache lines in the shared cache that correspond to the memory access request.

2. The apparatus of claim 1, further comprising a processor core to tag the memory access request with a pin indicia that corresponds to the one or more cache lines.

3. The apparatus of claim 1, further comprising a plurality of processor cores that access the shared cache with a same latency.

4. The apparatus of claim 1, further comprising a cache controller to copy data corresponding to the memory access request into the shared cache from a memory if the data is absent from the shared cache.

5. The apparatus of claim 1, wherein the shared cache comprises one or more of a lock status bit or a monitor status bit for each cache line.

6. The apparatus of claim 1, further comprising one or more processor cores to send the memory access request to the shared cache.

7. The apparatus of claim 6, wherein the one or more processor cores and the shared cache are on a same die.

8. The apparatus of claim 1, further comprising logic to monitor one or more addresses in the shared cache that correspond to the one or more cache lines.

9. The apparatus of claim 1, further comprising logic to suspend one or more memory requests to the one or more cache lines until the one or more cache lines are unlocked.

10. The apparatus of claim 1, further comprising logic to determine whether one or more locks in the shared cache have been released.

11. The apparatus of claim 1, further comprising logic to prevent one or more caches that have a lower level than the shared cache from storing the one or more cache lines.

12. The apparatus of claim 1, further comprising logic to determine which one of a plurality of processor cores is notified when the one or more cache lines are unlocked.

13. The apparatus of claim 12, wherein the plurality of processor cores execute a plurality of threads that are contending for the one or more cache lines.

14. The apparatus of claim 1, wherein the shared cache is a last level cache.

15. A method comprising:
receiving a memory access request to pin a lock in a shared cache; and
locking one or more cache lines in the shared cache that correspond to the memory access request.

16. The method of claim 15, further comprising tagging the memory access request with a pin indicia that corresponds to the one or more cache lines.

17. The method of claim 15, further comprising copying data corresponding to the memory access request from a memory into the shared cache if the data is absent from the shared cache.

18. The method of claim 15, further comprising suspending one or more memory requests to the one or more locked cache lines until the one or more locked cache lines are unlocked.

19. The method of claim 15, further comprising switching one or more threads that are contending for the one or more locked cache lines out of their respective processor cores.

20. The method of claim 15, further comprising locally spinning one or more threads that are contending for the one or more locked cache lines until the one or more locked cache lines are unlocked.

21. The method of claim 15, further comprising notifying a processor core executing one or more threads that are contending for the one or more locked cache lines when the one or more locked cache lines are unlocked.

22. The method of claim 15, further comprising preventing one or more caches that have a lower level than the shared cache from storing the one or more locked cache lines.

23. A system comprising:
a memory to store data;
a last level shared cache to store one or more cache lines that correspond to at least some of the data stored in the memory; and
a cache controller to:
lock one or more of the cache lines corresponding to an indicia; and
prevent one or more lower level caches from storing the one or more locked cache lines.

24. The system of claim 23, wherein the lower level caches comprise one or more of a level 1 cache and a mid-level cache.

25. The system of claim 23, wherein the cache controller copies data corresponding to the indicia into the last level cache from the memory if the data is absent from the last level cache.

26. The system of claim 23, further comprising a plurality of processor cores that access the last level cache with a same latency.

27. The system of claim 23, further comprising one or more processor cores to send the indicia to the last level cache.

28. The system of claim 27, wherein the one or more processor cores, the last level cache, and the cache controller are on a same die.

29. The system of claim 23, further comprising logic to determine which one of a plurality of processor cores is notified when the one or more cache lines are unlocked.

30. The system of claim 23, further comprising an audio device.

31. A processor comprising:
a plurality of processor cores to generate a memory access request;
a first cache and a second cache to share data between the plurality of processor cores; and
at least one cache controller coupled to the first cache to receive the memory access request and to lock one or more addresses in the first cache that correspond to the memory access request.

32. The processor of claim 31, wherein the plurality of processor cores access the first cache with a same latency.

33. The processor of claim 31, further comprising a memory to store data, wherein the first cache comprises one or more cache lines that correspond to at least some of the data stored in the memory.

34. The processor of claim 31, wherein the second cache has a lower level than the first cache.

35. The processor of claim 31, wherein the cache controller prevents the second cache from storing data corresponding to the one or more locked addresses.

36. The processor of claim 31, further comprising logic to determine which one of the plurality of processor cores is notified when one or more cache lines corresponding to the one or more locked addresses are unlocked.

37. The processor of claim 31, wherein the plurality of processor cores are on a same die.
